(19) United States
(12) Patent Application Publication
(10) Pub. No.: US 2024/0150203 A1
(43) Pub. Date: May 9, 2024

(54) DECOMPOSITION OF GAS FIELD CHEMICALS BY PLASMA TREATMENT

(71) Applicant: Saudi Arabian Oil Company, Dhahran (SA)

(72) Inventors: Mohammad Saad AlQahtani, Dhahran (SA); Abdulaziz Y. Ammar, Dammam (SA); Melhan M. Ben Sultan, Dammam (SA)

(21) Appl. No.: 17/980,705

(22) Filed: Nov. 4, 2022

(51) Int. Cl. C02F 1/46

(52) U.S. Cl. CPC C02F 1/4608; C02F 2101/32

(57) ABSTRACT

A method and a system for removing flow assurance chemicals from a produced water stream are provided. The method includes generating a plasma and treating the produced water stream with the plasma to form a treated water.

### TECHNICAL FIELD

The present disclosure is directed to a process for degrading flow assurance chemicals used in oil and gas fields.

### BACKGROUND

Produced water (PW) is the water produced as a byproduct during the production of crude oil and natural gas. PW contains suspended and dissolved solids, hydrocarbons, heavy metals, emulsified and non-soluble organics, as well as chemicals that are added during the extraction and production process. PW is considered by far the largest volume waste stream in oil and gas industries. Therefore, treating and reusing the produced water is highly desirable from both environmental and operational standpoints.

Natural gas hydrates are solid substances that trap hydrocarbons in a solid matrix of water. The hydrates are approximately 85 mol. % water, giving similar physical properties to ice. The gas hydrate is a crystalized water lattice or cage that is formed by combining water molecules with low molecular weight gas molecules. In the oil and gas industry, the gas molecules in the lattice structure can include methane, ethane, propane, isobutane, H₂S, CO₂, or nitrogen. Hydrates can accumulate on inner walls of pipes or fluid receptacles fouling equipment. The fouling can reduce production rates, plug transmission pipelines, or form ice balls that can act as solid projectiles damaging downstream instruments and processes. Therefore, hydrate formation is a significant operational and safety concern.

Hydrate inhibitors, such as kinetic hydrate inhibitors (KHIs), are substances, such as water-soluble polymers, that inhibit the formation of hydrates. For example, KHIs slow the nucleation or growth of hydrate crystals. Thus, treating a fluid stream with a KHI enables fluid streams to pass along a flow path with reduced hydrate formation. Most of the high-performance KHIs have solubility limitations based on temperature and salt content of the water. Generally, the KHIs become less soluble and even precipitate at higher temperatures and salt content of the water phase.

Polymer-based corrosion inhibitors (CIs) are also used extensively in oil and gas industry to ensure the integrity of pipelines and equipment. Similar to KHIs, CIs end up in the produced water and require treatment prior to water re-usage.

While hydrate inhibitors slow or prevent the formation of solid hydrates, they are often incompatible with conditions and other chemical found in wells, such as heat and salts. Under these conditions, the hydrate inhibitors can precipitate and damage formations. Therefore, produced water that has hydrate inhibitors may not be useful for injection water solutions, increasing the amount of water needed for gas and oil production in fields.

### SUMMARY

An embodiment described by example provides a method for removing flow assurance chemicals from a produced water stream. The method includes generating a plasma and treating the produced water stream with the plasma to form a treated water.

Another embodiment described in examples provides a system for removing hydrate inhibitors from produced water. The system includes a plasma generator (PG) unit to generate plasma and a plasma treatment vessel to contact produced water with the plasma.

### BRIEF DESCRIPTION OF DRAWINGS

FIG. 1 is a schematic drawing of a process for plasma treating in a plasma water reactor.

FIG. 2 is a schematic drawing of a two-step or indirect plasma treating process.

FIG. 3 is a simplified schematic diagram of a process using a batch plasma reactor to decompose a hydrate inhibitor in produced water.

FIG. 4 is a simplified schematic diagram of a process using a plasma water discharge reactor.

FIG. 5A is a simplified schematic diagram of a process for plasma water treatment using a gas discharge reactor.

FIG. 5B is a simplified schematic diagram of a process for plasma water treatment system using a water discharge reactor.

FIG. 5C is a simplified schematic diagram of a process for plasma water treatment using a hybrid gas-water discharge reactor.

FIG. 6 is a simplified process flow diagram of a system for plasma degradation of a hydrate inhibitor.

FIG. 7 is a process flow diagram of a method for removing hydrate inhibitors and other flow assurance chemicals from a feed stream.

### DETAILED DESCRIPTION

Embodiments described herein provide a plasma-based decomposition process for degrading kinetic hydrate inhibitor (KHI) in produced water streams, for example, from gas collection systems. Further, decomposition or oxidation of polymer-based corrosion inhibitors (CIs) can be achieved in the same process. The removal of the KHI from produced water allows the produced water to be reused, for example, by injection into reservoirs for enhanced oil recovery or well pressure maintenance. In addition to KHI/CIs removal, the plasma treatment could simultaneously degrade dispersed oil droplets, degrade dissolved hydrocarbon, destroy bacteria, and break stable oil emulsions, among others.

The active part of most commercially available KHI formulations is a synthetic polymer. The most commonly used synthetic polymer is a water miscible poly-n-vinylamide such as polyvinylcaprolactam (PVCap). KHI polymers can be organic, water miscible, or both. Example of polymers that can be used as KHIs include the following polymers or combinations or derivatives thereof: poly(vinylcaprolactam) (PVCap); polyvinylpyrrolidone; poly(vinylvalerolactam); poly(vinylazacyclooctanone); co-polymers of vinylpyrrolidone and vinylcaprolactam; poly(N-methyl-N-vinylacetamide); copolymers of N-methyl-N-vinylacetamide and acryloyl piperidine; co-polymers of N-methyl-N-vinylacetamide and isopropyl methacrylamide; co-polymers of N-methyl-N-vinyl acetamide and methacryloyl pyrrolidine; copolymers of acryloyl pyrrolidine and N-methyl-N-vinylacetamide; acrylamide/maleimide co-polymers such as dimethylacrylamide (DMAM) copolymerized with, for example, maleimide (ME), ethyl maleimide (EME), propyl maleimide (PME), or butyl maleimide (BME); acrylamide/maleimide co-polymers such as DMAM/methyl maleimide (DMAM/MME) and DMAM/cyclohexyl maleimide (DMAM/CHME); N-vinyl amide/maleimide co-polymers such as N-methyl-Nvinylacetamide/ethyl maleimide (VIMAlEME); lactam maleimide co-polymers such as vinylcaprolactam ethylmaleimide (VCap/EME); polyvinyl alcohols; polyamines; polycaprolactams; or polymers or co-polymers of maleimides, or acrylamides. While KHIs slow or prevent the formation of clathrate hydrates, they can precipitate at high temperatures, or high salt concentrations, which may cause formation damage, equipment fouling, or both.

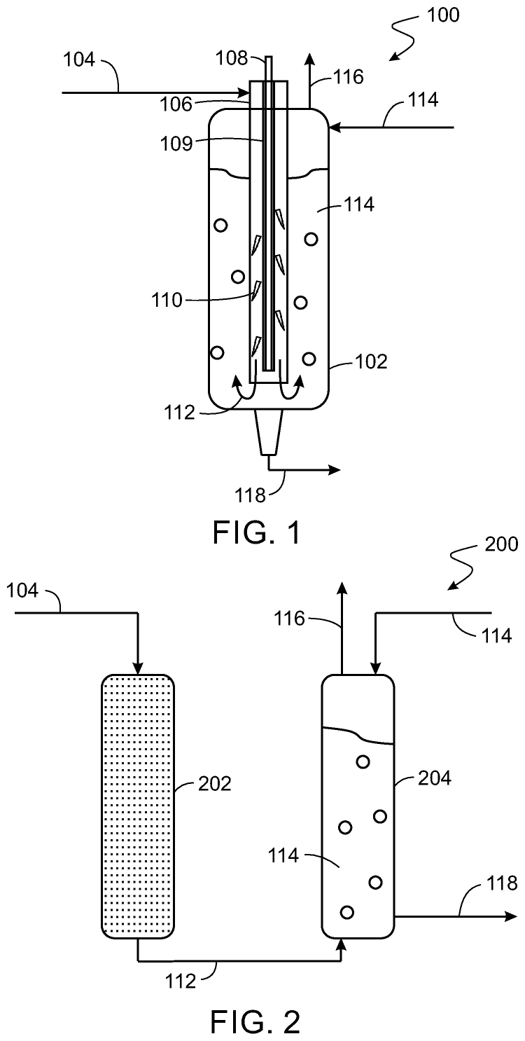

FIG. 1 is a schematic drawing of a process for plasma treating in a plasma water reactor 102. In the plasma water reactor 102, an oxidant gas 104 is introduced into a plasma tube 106. The oxidant gas 104 is oxygen, air, chlorine, or NOx's, or other oxidant gases. A high-voltage electrode 108 is placed in the plasma tube 106. The high-voltage electrode 108 is insulated from the plasma tube 106 by a dielectric coating 109 to form a dielectric barrier discharge (DBD) plasma. To form a DBD plasma, a dielectric material, such as a glass or ceramic coating over an electrode, is placed between the high voltage and grounding electrodes. The plasma tube 106 is coupled to the ground, and thus, is the grounding electrode. Accordingly, a dielectric barrier discharge is used to generate the plasma 110. Plasma 110 is formed by an electrical discharge between the high-voltage electrode 108 and the plasma tube 106, generating highly reactive species in the oxidant gas 104, creating a plasma-treated oxidant gas 112.

In some embodiments, the plasma tube 106 is made from a dielectric material, such as glass or quartz, and the high-voltage electrode 108 does not have a dielectric coating. In these embodiments, the produced water 114 is grounded, and the plasma 110 is formed by an electrical discharge between the high-voltage electrode 108 and the produced water 114 outside of the plasma tub 106, creating the plasma-treated oxygen gas 112.

In the direct method of FIG. 1, the plasma-treated oxidant gas 112 is then injected into the produced water 114, generating further reactive species in the produced water 114. In this embodiment, the short-lived excited states and activated species interact with the water and contribute in the decomposition process. The species generated by the interaction of the oxidant gas 104 that is injected into the produced water 114 may include radicals, atoms, excited molecules, protons, and free electrons. For example, the energetic and reactive species generated can include ·OH, ·O, HO₂·, O₃, H₂O₂, H·, and free electrons, among others.

The reactive species can interact with polymer-based KHI in the produced water 114, and other chemicals, to cause decomposition, for example, by oxidation. A number of reactions, for example, shown in R1-R7, can take place in the plasma discharge and the produced water 114 depending on the nature of the plasma 110 and the oxidant gas 104. Further, different types of plasma 110 can be used to treat the produced water 114, as generated using different techniques. For example, in addition to DBD; the plasma 110 can be generated corona discharge, pulse corona discharge, microwaves, or arc discharge.

O₂+e⁻→2O·+e⁻ R1

2O₂+e⁻→O₃+O·+e⁻ R2

H₂O+e⁻→H·+·OH+e⁻ R3

H₂O+O·→2·OH R4

2H₂O+e⁻→H₂O₂+H₂+e⁻ R5

·OH+H₂O₂→H₂O+HO₂· R6

O₃+H₂O₂→·OH+O₂+HO₂· R7

A wide range of operating conditions, such as voltage, frequency, geometry, treatment time, pressure, temperature, and oxidant flow rate, can be tuned based on the desired type of the plasma 110, the concentration of the flow assurance chemicals, and the like. For example, the plasma high voltage for the DBD reactor can range from about 1 kV to about 50 kV with a frequency ranging from lower radio frequency (RF), e.g., 30 kHz, or lower, to microwave frequencies, e.g., 500 MHz, or higher. The residence time may be in a range from 0.5 s to 10 hours, or more. The residence time depends on whether a continuous or a batch process is used.

Plasma can be operated freely (similar to FIG. 2), with pressure from 1-10 bars, and temperature from 20-900° C. However, if the plasma generated within the water, the temperature should be less than 100° C. to prevent water evaporation and the pressure is around atmospheric pressure.

After treatment, the spent oxidant gas 116 is vented from the plasma water reactor 102. The treated water 118 exiting the plasma water reactor 102 contains a much lower concentration of KHI and other chemicals. The plasma-based water treatment process can be a direct one-step treatment process, as shown in FIG. 1, or an indirect two-step treatment process, as shown in FIG. 2.

FIG. 2 is a schematic drawing of a two-step or indirect plasma treating process 200. Like numbered items are as described with respect to FIG. 1. In the indirect process, plasma is generated in the oxidant gas 104 in a separate plasma-gas reactor 202, and then the plasma-treated oxidant gas 112 is injected into the produced water 114 in a treatment tank 204. The indirect process is easier to design and operate, but only species or molecules with a relatively long lifetime, such as O₃, reach the produced water 114.

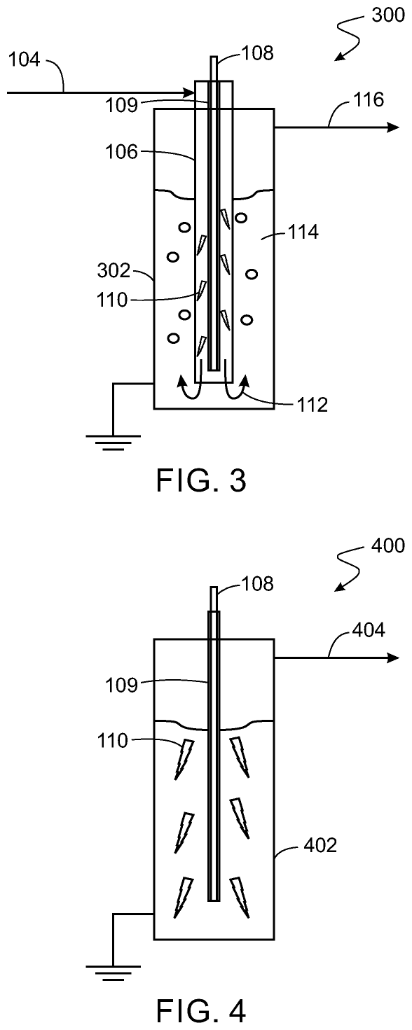

FIG. 3 is a simplified schematic diagram of a process 300 using a batch plasma reactor 302 to decompose a hydrate inhibitor in produced water. Like numbered items are as described with respect to FIG. 1. Different configurations for the plasma water reactor can be used. For example, in the configuration of FIG. 3, the oxidant gas 104 is added to the plasma tube 106, but the produced water 114 is not continuously flowed through the batch plasma reactor 302. This may be useful if the concentration of KHI, and other chemicals, is higher than the amount in the produced water 114 of the continuous process shown in FIG. 1. As for the configurations shown in FIGS. 1 and 2, the configurations shown in FIGS. 3 and 4 are dielectric barrier discharge systems.

As shown in FIGS. 1-3, in some embodiments the plasma 110 interacts only with the oxidant gas 104 to activate it, termed a plasma-gas discharge. In other embodiments, the plasma 110 interacts directly with the produced water 114, termed a plasma-water discharge. This is discussed further with respect to FIG. 4.

FIG. 4 is a simplified schematic diagram of a process 400 using a plasma water discharge reactor 402. Like numbered items are as described with respect to FIG. 1. In this embodiment, the plasma 110 is directly formed in the produced water 114. As for the embodiment shown in FIG. 3, this is a batch process. Although the plasma-water discharge could have a higher decomposition rate for the KHI and other chemicals, the generation of the plasma 110 usually requires a much higher voltage. The decomposition of the KHI will result in the formation of gas 404, for example, carbon dioxide.

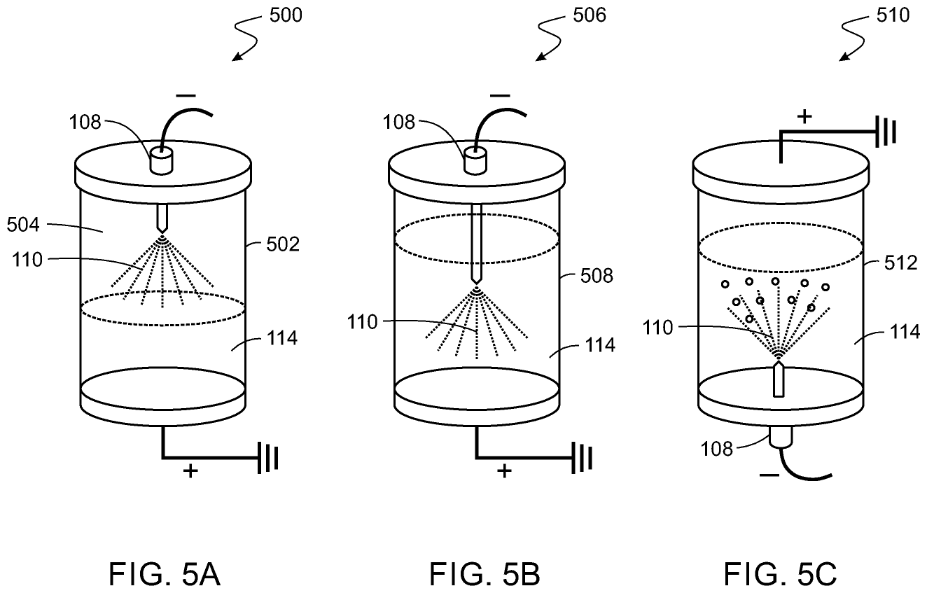

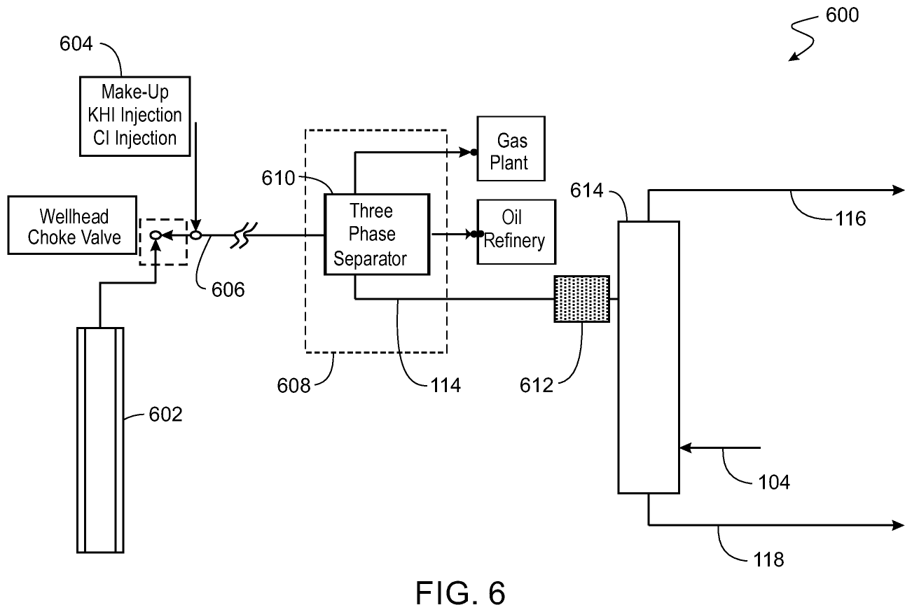

The use of the plasma treatment is not limited to DBD type reactors. As described with respect to FIGS. 5A to 5C, direct treatment with plasma formed by a corona discharge or arc discharge can be used.

FIG. 5A is a simplified schematic diagram of a process 500 for plasma water treatment using a gas discharge reactor 502. Like numbered items are as described with respect to FIG. 1. In this process 500, the plasma 110 is formed by the high-voltage electrode 108 in the gaseous headspace 504 of the gas discharge reactor 502. The plasma 110 then showers the surface of the produced water 114.

FIG. 5B is a simplified schematic diagram of a process 506 for plasma water treatment system using a water discharge reactor 508. In this embodiment, the high-voltage electrode 108 is in direct contact with the produced water 114. Accordingly, the plasma 110 is produced from the bare electrode under the surface of the produced water 114.

FIG. 5C is a simplified schematic diagram of a process 510 for plasma water treatment using a hybrid gas-water discharge reactor 512. This configuration is a hybrid of the configurations shown in 5A and 5B.

FIG. 6 is a simplified process flow diagram of a system 600 for plasma degradation of a hydrate inhibitor. Like numbered items are as described with respect to FIGS. 1 and 2. Gas and/or oil produced from a well 602 often has entrained water, which, as discussed herein, can form clathrate hydrates. Hydrate inhibitors 604, such as kinetic hydrate inhibitors, are often added to slow or prevent the formation of hydrates, especially in trunk, or collection, lines 606 in a gas or oil field. Further, other chemicals, such as corrosion inhibitors, may be added.

The trunk lines 606 feed the fluid, which consists of water, gas and/or oil to a Gas-Oil Separation Plant (GOSP) 608. In the GOSP 608, a three-phase separator 610 separates the produced water 114. The produced water 114 may be treated in a filtration unit 612 before being sent to a plasma treatment unit 614, for example, as described with respect to FIGS. 1-5C.

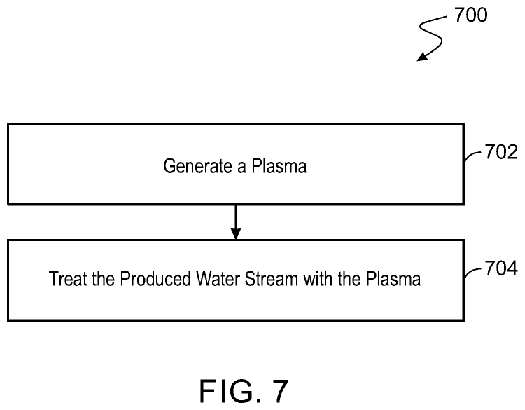

FIG. 7 is a process flow diagram of a method 700 for removing hydrate inhibitors and other flow assurance chemicals from a feed stream. The method begins at block 702 with generating a plasma at a high-voltage electrode, a microwave emitter, a spark gap, or other system. As described herein, the plasma may be generated in an oxidant gas, a headspace above a produced water, or directly in the produced water. The flow assurance chemicals can include kinetic hydrate inhibitors, other hydrate inhibitors, corrosion inhibitors, and the like. The produced water is a water stream separated from a fluid stream containing gas and/or oil, for example, in a gas collection system, a pipeline to a gas plant, and the like. The kinetic hydrate inhibitor is often added at the wellhead to prevent the formation of hydrates from the entrained water in the gas stream.

At block 704, produced water is treated with the plasma to form a treated water stream. In some embodiments, an oxidant gas that has been treated in a plasma reaction is mixed with the produced water. In other embodiments, the plasma is formed directly in the produced water. As described herein, in the plasma treatment process, a plasma discharge from a high voltage electrode creates reactive species that oxidize or otherwise decompose KHI and other flow assurance chemicals in the produced water.

Some produced water streams contain metal ions such as Iron (Fe²⁺) or Copper (Cu²⁺). During the plasma treatment, the presence of metal ions enhances the KHI oxidation due to the Fenton reactions, shown in R8-R12. Metal ions can act as a catalyst to promote the oxidizing power of the reactive species by the production of ·OH radicals. In some embodiments, for example, if the produced water does not contain metal ions, the metal ions are added, for example, as salts, to enhance the oxidation.

Fe²⁺+H₂O₂→Fe³⁺+·OH+OH⁻ R8

Fe²⁺+·OH→Fe³⁺+OH⁻ R9

Fe²⁺+OH⁻→Fe(OH)²⁺ R10

Fe(OH)²⁺+hv→Fe²⁺+·OH R11

·OH+H₂O₂→HO₂+H₂O R12

### Examples

A small lab scale plasma-water reactor similar to FIG. 3 was used to demonstrate the removal of KHI from water. 250 ml of dry air was activated by plasma and immediately injected into 250 ml water-containing KHI (poly N-isopropyl methacrylamide). The water initially had 1% (v/v) KHI. After, 1 h of treatment, 10% of the KHI decomposed; after 2 h, around 18% of the KHI was removed as shown in the table below.

| Water Sample | KHI % in water | Removal efficiency (%) |
|---|---|---|
| Before treatment | 1 | 0 |
| After 60 min plasma | 0.9 | 10 |
| treatment | | |
| After 120 min plasma | 0.82 | 18 |
| treatment | | |

### Embodiments

An embodiment described by example provides a method for removing flow assurance chemicals from a produced water stream. The method includes generating a plasma and treating the produced water stream with the plasma to form a treated water.

In an aspect, the method includes flowing a gas around a high-voltage electrode and flowing the gas into the produced water stream to form the treated water.

In an aspect, the gas includes an oxidant gas. In an aspect, the gas includes oxygen.

In an aspect, the method includes generating the plasma in a plasma reactor, flowing gas through the plasma reactor, and flowing the gas into the produced water stream to form the treated water. In an aspect, the gas includes an oxidant gas. In an aspect, the gas includes oxygen.

In an aspect, the method includes generating the plasma with a dielectric barrier discharge electrode. In an aspect, the method includes generating the plasma with a pulse corona discharge. In an aspect, the method includes generating the plasma with an arc discharge.

In an aspect, the method includes treating the produced water in a batch process. In an aspect, the method includes treating the produced water in a continuous process. In an aspect, the method includes generating the plasma in the produced water. In an aspect, the method includes generating the plasma above the produced water.

In an aspect, the flow assurance chemicals include a hydrate inhibitor, a hydrocarbon, a corrosion inhibitor, or any combinations thereof.

In an aspect, the method includes adding a metal ion to the water stream to enhance oxidation during the plasma treatment of produced water.

Another embodiment described in examples provides a system for removing hydrate inhibitors from produced water. The system includes a plasma generator (PG) unit to generate plasma and a plasma treatment vessel to contact produced water with the plasma.

In an aspect, the PG unit includes a plasma tube inserted into the plasma treatment vessel, wherein a flow of an oxidant gas through the plasma tube is released into the produced water in the plasma treatment vessel.

In an aspect, the PG unit includes a plasma-gas reactor fluidically coupled to the plasma treatment vessel.

In an aspect, the PG unit includes a high-voltage electrode that includes a dielectric barrier.

In an aspect, the PG unit includes a high-voltage electrode that is inserted into the plasma treatment vessel above a surface of the produced water.

In an aspect, the PG unit includes a high-voltage electrode is inserted into the plasma treatment vessel below a surface of the produced water.

Other implementations are also within the scope of the following claims.

What is claimed is:

1. A method for removing flow assurance chemicals from a produced water stream, comprising
generating a plasma; and
treating the produced water stream with the plasma to form a treated water.

2. The method of claim 1, comprising:
flowing a gas around a high-voltage electrode; and
flowing the gas into the produced water stream to form the treated water.

3. The method of claim 2, wherein the gas comprises an oxidant gas.

4. The method of claim 2, wherein the gas comprises oxygen.

5. The method of claim 1, comprising:
generating the plasma in a plasma reactor;
flowing gas through the plasma reactor; and
flowing the gas into the produced water stream to form the treated water.

6. The method of claim 5, wherein the gas comprises an oxidant gas.

7. The method of claim 5, wherein the gas comprises oxygen.

8. The method of claim 1, comprising generating the plasma with a dielectric barrier discharge electrode.

9. The method of claim 1, comprising generating the plasma with a pulse corona discharge.

10. The method of claim 1, comprising generating the plasma with an arc discharge.

11. The method of claim 1, comprising treating the produced water in a batch process.

12. The method of claim 1, comprising treating the produced water in a continuous process.

13. The method of claim 1, comprising generating the plasma in the produced water.

14. The method of claim 1, comprising generating the plasma above the produced water.

15. The method of claim 1, wherein the flow assurance chemicals comprise a hydrate inhibitor, a hydrocarbon, a corrosion inhibitor, or any combinations thereof.

16. The method of claim 1, comprising adding a metal ion to the water stream to enhance oxidation during the plasma treatment of produced water.

17. A system for removing hydrate inhibitors from produced water, comprising:
a plasma generator (PG) unit to generate plasma; and
a plasma treatment vessel to contact produced water with the plasma.

18. The system of claim 17, wherein the PG unit comprises a plasma tube inserted into the plasma treatment vessel, wherein a flow of an oxidant gas through the plasma tube is released into the produced water in the plasma treatment vessel.

19. The system of claim 17, wherein the PG unit comprises a plasma-gas reactor fluidically coupled to the plasma treatment vessel.

20. The system of claim 17, wherein the PG unit comprises a high-voltage electrode that comprises a dielectric barrier.

21. The system of claim 17, wherein the PG unit comprises a high-voltage electrode that is inserted into the plasma treatment vessel above a surface of the produced water.

22. The system of claim 17, wherein the PG unit comprises a high-voltage electrode is inserted into the plasma treatment vessel below a surface of the produced water.
